(19) United States
(12) Patent Application Publication
(10) Pub. No.: US 2024/0119385 A1
(43) Pub. Date: Apr. 11, 2024

(54) METHODS AND SYSTEMS FOR DISCOVERY AND MONITORING OF BUSINESS FLOWS

(71) Applicants: SHRIDHAR VENKATRAMAN, CAMPBELL, CA (US); RAKESH SUBBURAJ, COIMBATORE (IN); ALOKE GUHA, LOUISVILLE, CO (US); SANKAR NAGARAJAN, CHENNAI (IN); SHOUVIK SARDAR, CHENNAI (IN)

(72) Inventors: SHRIDHAR VENKATRAMAN, CAMPBELL, CA (US); RAKESH SUBBURAJ, COIMBATORE (IN); ALOKE GUHA, LOUISVILLE, CO (US); SANKAR NAGARAJAN, CHENNAI (IN); SHOUVIK SARDAR, CHENNAI (IN)

(21) Appl. No.: 18/223,531

(22) Filed: Jul. 18, 2023

Related U.S. Application Data
(60) Provisional application No. 63/390,632, filed on Jul. 19, 2022.

(51) Int. Cl. G06Q 10/0633

(52) U.S. Cl. CPC G06Q 10/0633

(57) ABSTRACT

In one aspect, a method for automated discovery of business flows comprising: business transaction or trace data collected from requests being submitted from and to an application; and parsing each incoming trace data based on different service operations within the trace data to find unique business flows; and aggregating and compressing traces that have same repeated services and or operations into the same business flow to reduce the number of business flows for more efficient collection and monitoring by the business flow processing controller.

### CLAIM OF PRIORITY

This application claims priority to U.S. Provisional Patent Application No. 63/390,632, filed on 19 Jul. 2022, and titled METHODS AND SYSTEMS FOR ANALYZING TRACES FOR OBSERVABILITY. This provisional patent application is hereby incorporated by reference in its entirety.

### BACKGROUND

Traces are a key telemetry used for diagnosing problems in services, having become a key pillar of observability for the application and development teams but increasingly also for Operations (Ops). However, the sheer number of traces, tied to the number of business flow transactions per hour can be a significant challenge especially for Ops teams that are trying to detect and isolate problems in near real time. Typically, given the volume and diversity of different transactions and calls, most Ops face some significant challenges.

### SUMMARY OF THE INVENTION

In one aspect, a method for automated discovery of business flows comprising: business transaction or trace data collected from requests being submitted from and to an application; and parsing each incoming trace data based on different service operations within the trace data to find unique business flows; and aggregating and compressing traces that have same repeated services and or operations into the same business flow to reduce the number of business flows for more efficient collection and monitoring by the business flow processing controller.

### BRIEF DESCRIPTION OF THE DRAWINGS

FIG. 1 illustrates an example process for implementing a trace path concept, according to some embodiments.

FIG. 2 illustrates an example trace graph, according to some embodiments.

FIG. 3 illustrates an example table showing trace graph metrics, according to some embodiments.

FIG. 4 illustrates an example process, according to some embodiments.

Examples of trace paths collected and summarized are shown in FIG. 5, according to some embodiments.

FIG. 6 illustrates a screen shot of how one can then find traces at specific time interval for a given trace path that contains specific services, according to some embodiments.

FIG. 7 illustrates an example screenshot of aggregated metrics on selected trace path during a specified time interval, according to some embodiments.

FIG. 8 illustrates an example screen shot of a list of all traces in a selected trace path during a specified time interval, according to some embodiments.

FIG. 9 illustrates an example screen shot of subsequently drill down to specific trace of interest, according to some embodiments.

FIG. 10 illustrates an example screen shot showing monitoring trace path Performance, according to some embodiments.

FIG. 11 illustrates an example screen shot showing drilling down to trace that breached its SLO, according to some embodiments. embodiments.

The Figures described above are a representative set and are not exhaustive with respect to embodying the invention.

### DESCRIPTION

Disclosed are a system, method, and article of manufacture for discovery and monitoring of business flows. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote services and/or software networks can be a collection of remote computing services.

Service-level objective (SLO) is a key element of a service-level agreement (SLA) between a service provider and a customer. SLOs are agreed upon as a means of measuring the performance of the Service Provider and are outlined as a way of avoiding disputes between the two parties based on misunderstanding.

### Exemplary Methods and Systems

The following description provides a hierarchical approach to address cardinality challenges of analyzing traces using a new concept of trace paths. These have some significant benefits including, inter alia:
Automated trace path discovery—especially useful when there are a large number or volume of traces (i.e., number of traces or requests per second);
Automated problem detection using compact models with few parameters while being relatively invariant to the length of the trace path;
Automated real-time detection of problems in the trace path to enable Ops to drill down to problem traces for further diagnostics;
Automated isolation of problem Services and Operations using multiple contextual indications from other telemetry as well as predictive anomaly detection on the trace path and its components for taking remediation actions; and
Improving scalability of trace path discovery and monitoring by distributing the processing through added intelligence at the collection edge.

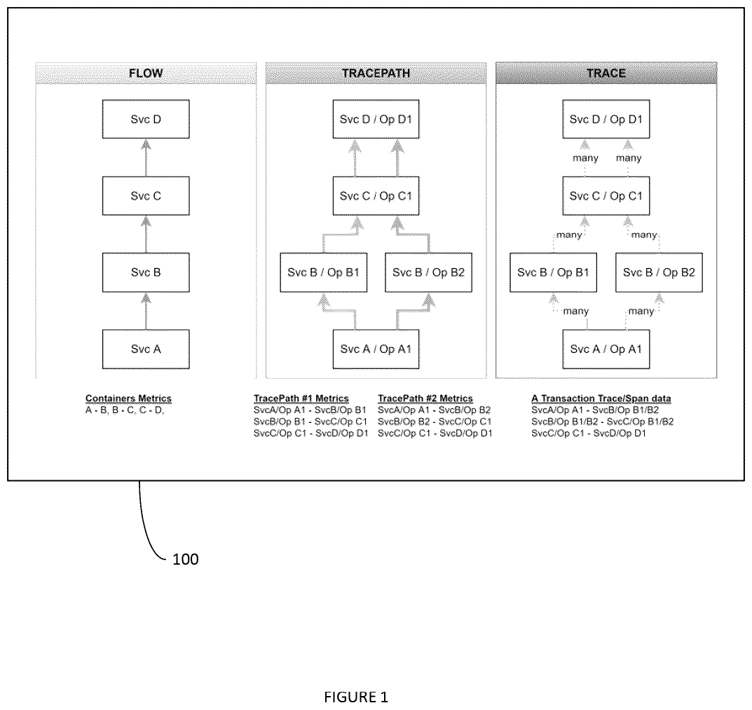

FIG. 1 illustrates an example process 100 for implementing a trace path concept, according to some embodiments. To address Ops' need for real-time alerting on the most frequently occurring traces and by aggregating the metrics on the performance of the routes taken by the traces. Trace paths are unique business flows created by traces through the application environment. A unique characteristic of trace path is that they can be discovered in real-time. Trace paths (TPs) are the common routes and their performance is characterized by the following:
Modeled as graph, called the trace graph, of connected edges;
The graph vertices are Service/Operations within the trace paths;
Service/Operations pair can be in multiple trace paths; and
The performance of a trace path can be measured as the aggregate of the flow performance metrics of edges that comprise the trace path.

Trace graph metrics are now discussed. The trace path and the associated edges are sent to the Observability Controller (henceforth referred to as the controller) for analysis and extracting insights on the trace paths. The high volume of traces that are possible, and the variation within the traces due to different combinations of the Service/Operations leads to a high cardinality challenge. To address this cardinality challenge and associated volume of data to be processed and monitored, the number of trace paths should be significantly smaller than the number of traces. To arrive at a minimal number of possible trace paths, one can maximize the number of traces per trace path by a series of aggregation and compression steps.

These can include, inter alia:
Aggregating Repetitive Spans or Loops when Operations within the same Service are called; and
Consolidating Service/Operation tuples or merging the different Operations within the Service. These allow reducing the number of unique trace paths without losing fidelity in discrimination.

It is noted that sensitivity in detecting trace paths can be increased by the use of “baggage” attributes so as to discriminate elements that cause new trace paths to be formed.

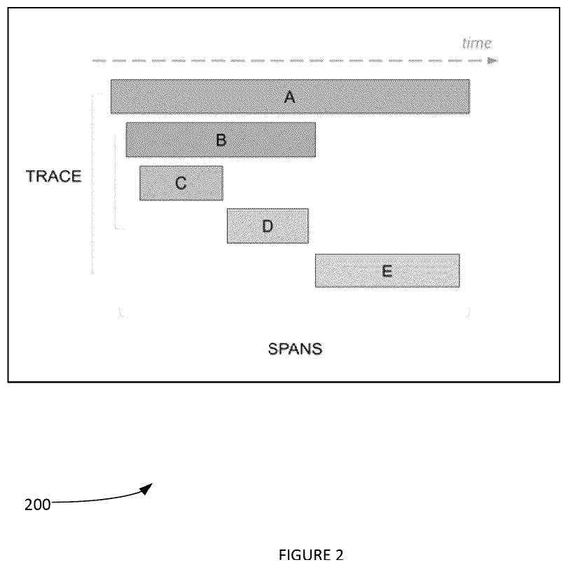

FIG. 2 illustrates an example trace graph 200, according to some embodiments. Trace graph 200 is generated by a trace path.

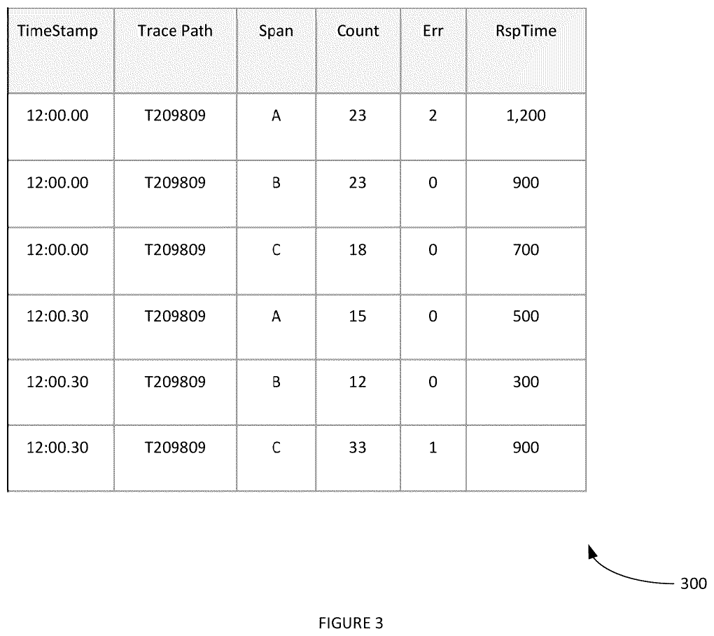

FIG. 3 illustrates an example table 300 showing trace graph metrics, according to some embodiments. Table 300 illustrates Trace graph metrics of a trace path. For the example trace graph 200, the trace graph metrics that include the volume of incoming requests per span and performance such as response times, that can be sent to the Controller are shown in table 300.

Trace path variants are now discussed. A trace path can have additional attributes, specific to request type, custom metadata related to the source, etc. and these created variations, or variants, of the trace path and can be added as additional traits. The creation of such variants allow Ops teams to track and monitor specific transactions of interest, especially in the event of performance problems or failures.

Variants can be created in different ways using a combination of tags or fields within the trace. Some examples can include, inter alia:
Variants on performance or availability: performance metrics such as latency or availability metrics such as error counts on the complete trace path or Service/Operations within the trace path to check if SLOs are being met;
Variants on specific class of transactions: performance or availability of a particular type of business flow so as to: compare latencies of traces of one class of product category versus another and/or compare latencies of traces when requests are from different geographical areas;
Variants based on physical infrastructure resources and deployments to: check how trace paths that use specific infrastructure such as servers and associated storage or networks affect performance and availability and/or detect whether trace paths that share the same physical hardware are failing because of the underlying infrastructure;
Variants that can exist for some Service/Operations without existence of the trace path in that sample interval;
Some Service/Operations present tags that can generate variants in that part of the transaction flow for the same trace path; and
Incorporating different tags or attributes to create variants of a trace path can create a high cardinality problem given the number of possible combinations of the trace graph vertices and edges, which in turn would create a high computational load in the controller.

To avoid increasing cardinality, the variants can be added as sub-objects instead of creating each variant as a different trace path. The sub-objects are stored as labels in metric time series, and information on the variants can be captured as baggage items. These sub-object can be queried later for further insights into specific traces with the same traits.

Monitoring trace paths and traces require using trace paths that provide the real-time monitoring of business flows once the trace paths have been discovered. By creating specific service level objectives (SLOs) on trace paths of interest, example processes can detect when those SLOs are not being met or breached and then drill down to traces that have caused the breach.

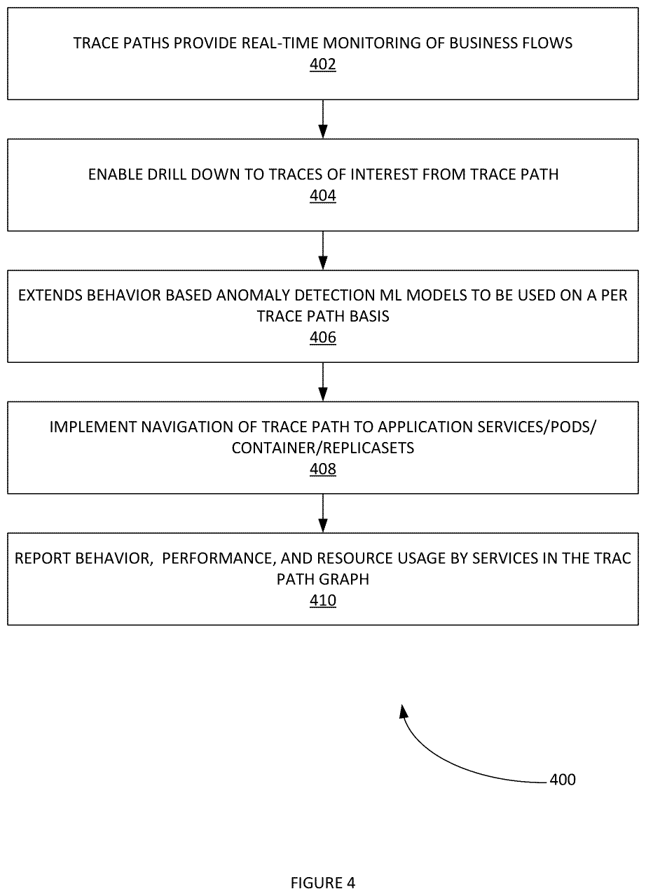

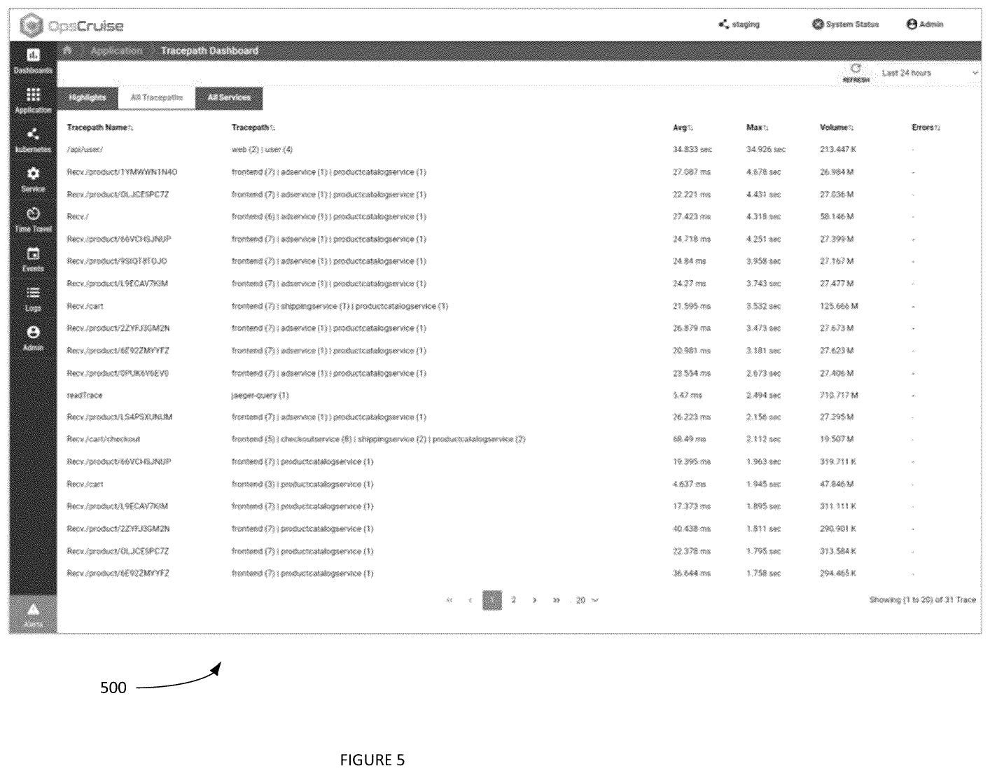

FIG. 4 illustrates an example process 400s, according to some embodiments. A trace path can have additional attributes, specific to request type, custom metadata related to the source, etc. and these created variations of the trace path and can be added as additional traits.

However, incorporating these attributes, creates a high cardinality problem: #{vertices+edges} combinations, which would create a high computational load in the controller. To avoid increasing cardinality, the variants can be added as sub-objects instead of creating each variant as a different trace path. The sub-objects are stored as labels in metric time series, and information on the variants can be captured as baggage items. These sub-object can be queried later for further insights into specific traces with the same traits.

More specifically, in step 402 trace paths provide real time monitoring of business flows. In step 404, process 400 can enable drill down to traces of interest from trace path. In step 406, process 400 extends behavior-based anomaly detection ml models to be used on a per trace path basis. In step 408, process 400 implements navigation of trace path to application services/pods/container/replica sets. In step 410, process 400 reports behavior, performance, and resource usage by services in the trace path graph.

Automated Discovery of trace paths is now discussed. By examining different traces that are captured and looking for commonalities, the trace paths can be detected automatically. This reduces the burden on the Ops teams to do this manually. Examples of trace paths 500 collected and summarized are shown in FIG. 5, according to some embodiments. FIG. 5 shows an example list of discovered trace paths.

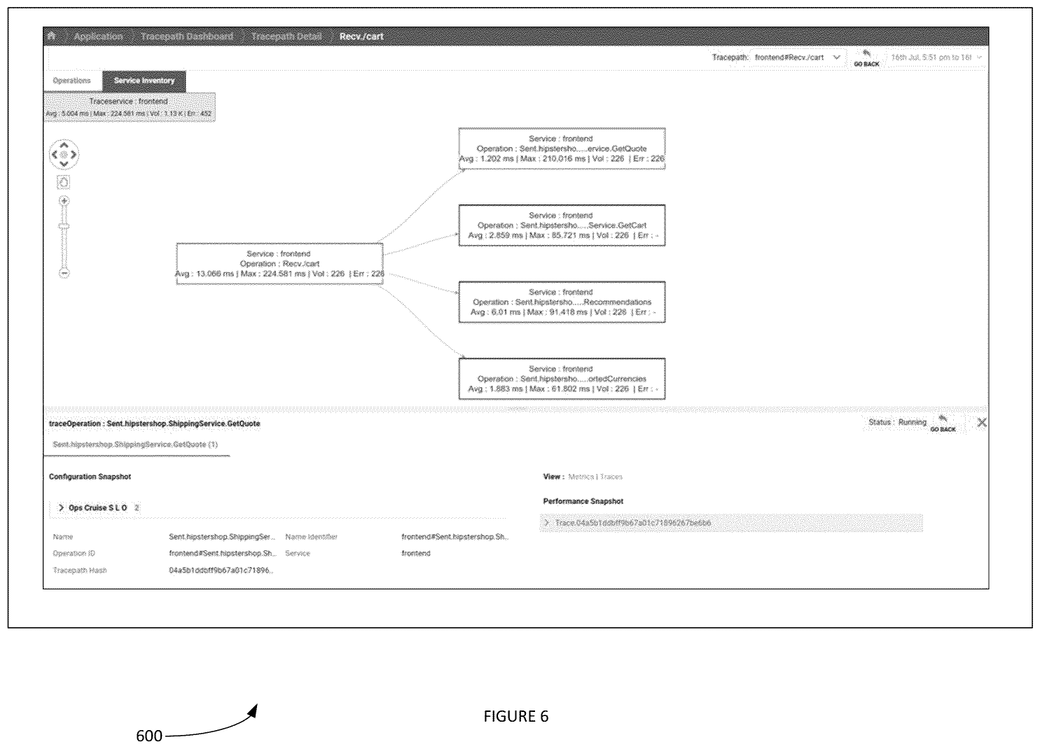

Once trace paths have been identified, one can select a trace from the list as shown in FIG. 5 and find traces that have occurred at specific time interval for a given trace path as shown in FIG. 6.

FIG. 6 illustrates a screen shot 600 of how one can then find traces during a specific time interval for a given trace path that contains specific services, according to some embodiments.

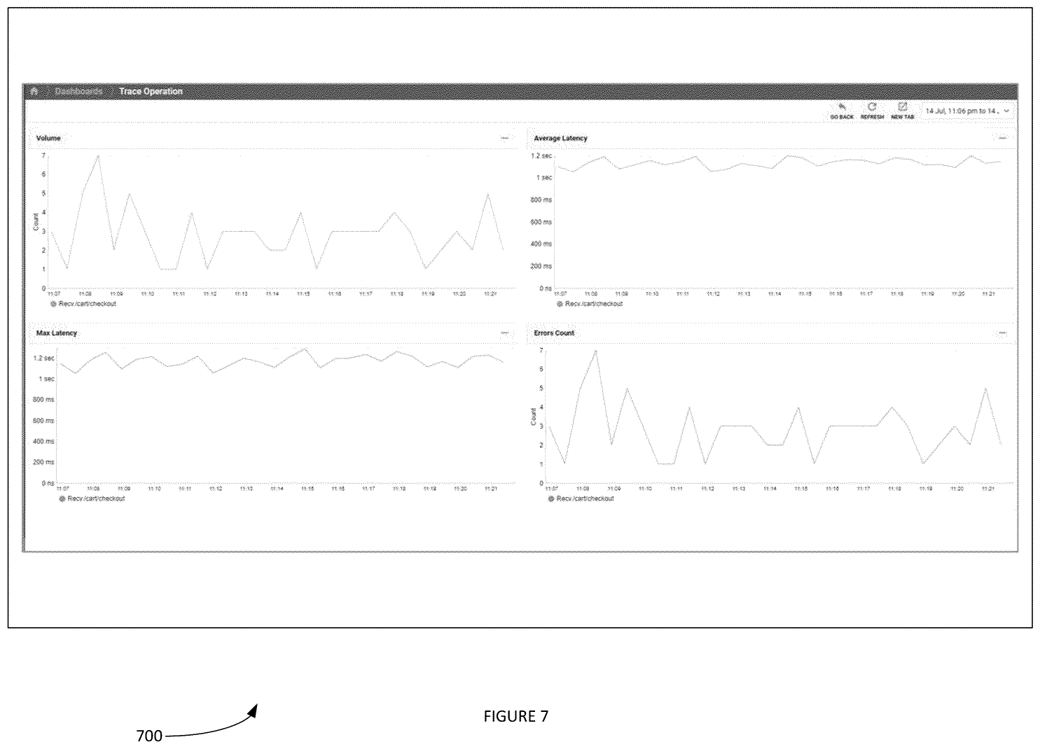

FIG. 7 illustrates an example screenshot 700 of aggregated metrics on selected trace path during a specified time interval, according to some embodiments.

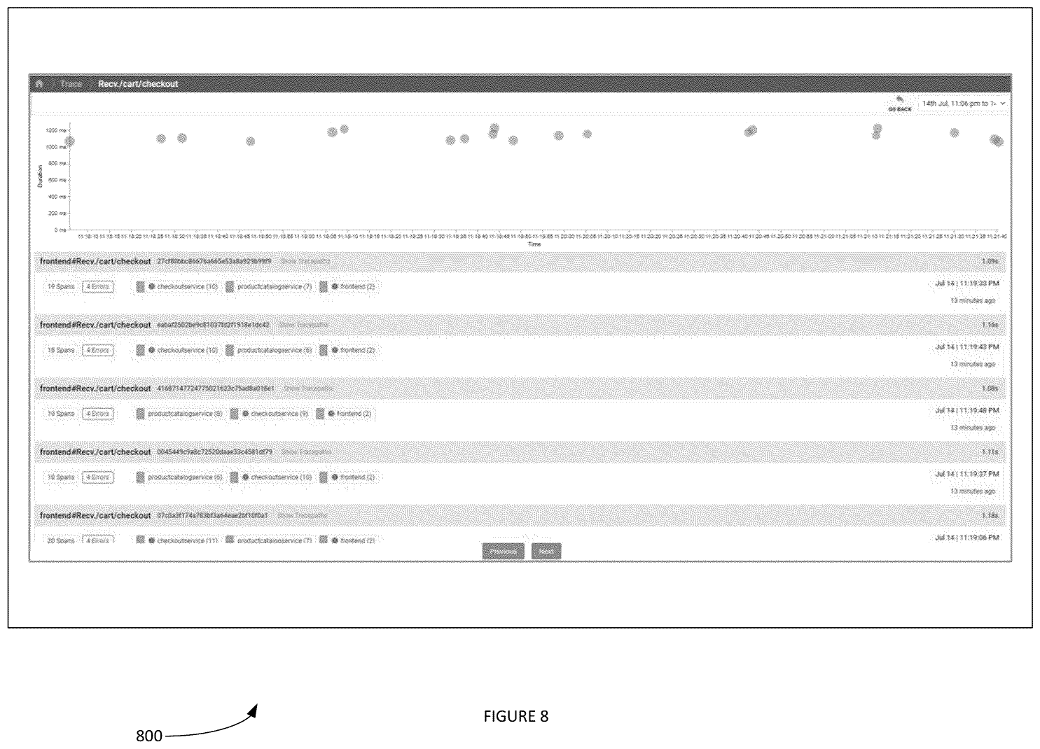

The list of all traces belonging to the trace path that occurred during the specified time interval can also be retrieved as shown in FIG. 8.

FIG. 8 illustrates an example screen shot 800 of a list of all traces in a selected trace path during a specified time interval, according to some embodiments.

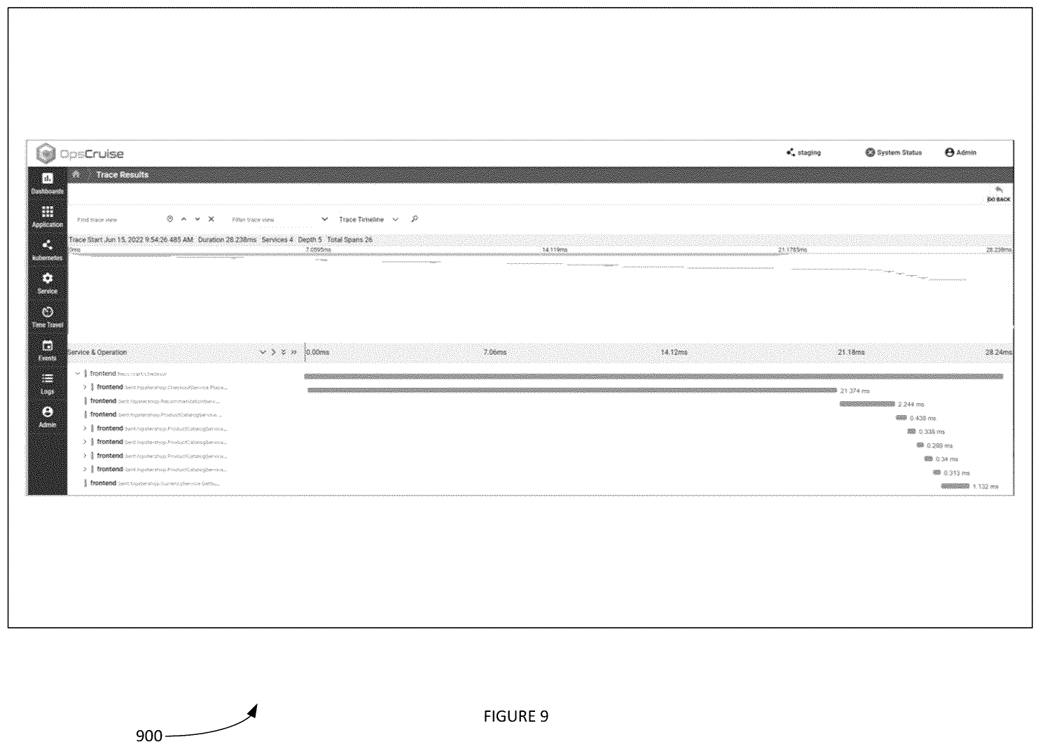

FIG. 9 illustrates an example screen shot 900 of subsequently drill down to specific trace of interest, according to some embodiments. Aggregate metrics that are collected on the trace path can then be retrieved as shown. As shown, the process can drill down to a trace of selected trace path during a specified time interval.

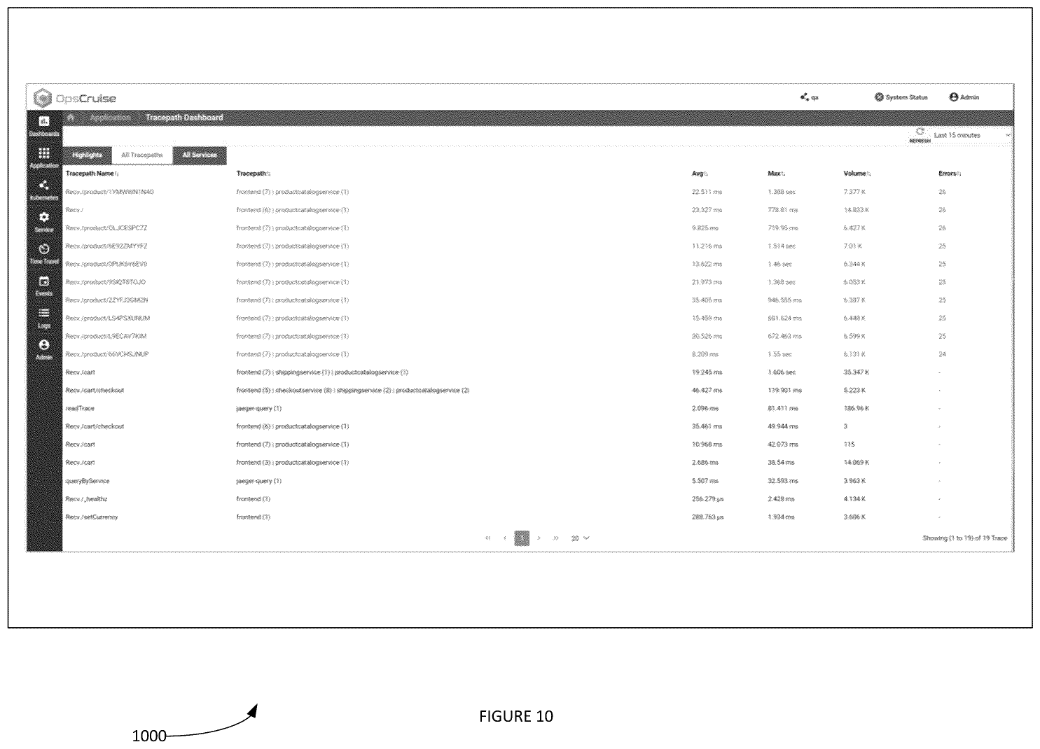

FIG. 10 illustrates an example screen shot 1000 showing monitoring trace path performance, according to some embodiments. Screen shot 1000 shows how to identify trace paths that have breached their SLOs, in red font, that were automatically set using such quantile sketch methods. Once the problem trace paths are detected, one can drilldown to the problem trace as shown in FIG. 10. Real-Time trace path Problem Detection and Isolation is now discussed. The process and workflow as an example would as follows. All trace paths can be identified. The method can set SLOs on response time using automated SLO selection. The method can use different methods including machine learning models per trace path. The method can implement a Runtime SLO breach detection or detect anomalies using the learned behavior model. The method can isolate services causing the anomaly.

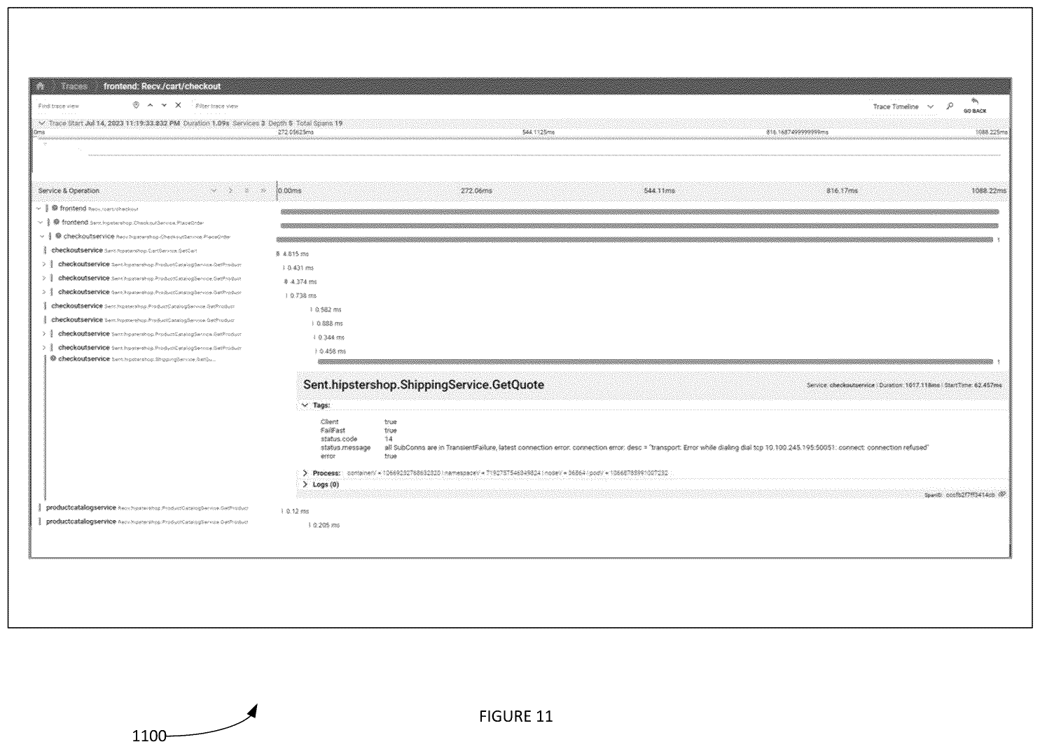

FIG. 11 illustrates an example screen shot 1100 showing drilling down to trace that breached its SLO, according to some embodiments.

Cause Isolation on trace path SLO Breach is now discussed. Additionally, once the problem trace or traces have been detected, one can examine which Service and Service Operations are the likely cause based on a number of other indicators, such as associated events or logs on failures, as also shown in FIG. 11. Beyond explicit determination of cause such as contextually linked failures from logs or events, example processes can also use other methods to find anomalies on the Services and Service Operations. As an example, this would include using behavior-based ML models on the trace paths as has been done for microservices to detect emerging anomalies on trace paths without relying on explicit SLO breaches. Models for trace path can include different parameters and be as granular as detecting problems on individual Services and Service/Operations including, inter alia:
Total Volume of requests;
Total Errors;
Different percentiles of response times;
Different percentiles of the ratio between response time and request count; and
Different percentiles of the ratio between error count to request count, etc.

Using Distributed Processing for Scaling trace path Processing.

A challenge in collecting and processing traces to discover trace paths is the potentially very high volume of data generated by the traces. This has several implications, including:
High bandwidth network requirement between the edge collection points of the trace for forwarding to the processing controller, and
Large amount of storage for maintaining all the traces during the processing at the controller

Moving high volume of data takes more time and introduces delays in processing the traces and detecting problems in them.

Example processes can reduce both requirements through distributed processing by adding intelligence at the edge where traces are collected. In such a scenario a number of processing methods are used at the edge that include, inter alia: sending the trace path definition the first time they are found, and then only forward metrics of trace paths and constituent service/operations from the edge every sample interval; and check for SLO breaches such as performance metrics or error counts at the edge and only forward those traces and trace path metrics.

By applying such edge intelligence and reducing the processing at the controller, one can improve both scalability in the volume of traces that can be monitored as well as reduce the processing infrastructure needs, besides improving real-time detection of problem traces.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is as follows:

1. A method for automated discovery of business flows comprising:
business transaction or trace data collected from requests being submitted from and to an application; and
parsing each incoming trace data based on different service operations within the trace data to find unique business flows; and
aggregating and compressing traces that have same repeated services and or operations into the same business flow to reduce the number of business flows for more efficient collection and monitoring by the business flow processing controller.

2. The method of claim 1 further comprising:
monitoring business flows and traces that belong to the same business flow.

3. The method of claim 2 further comprising:
based on metrics related to performance, availability or other defined or derived attribute such as level of traffic or number of requests; and
providing real-time monitoring of all traces by monitoring only discovered business flows without checking each trace individually.

4. The method of claim 3 for updating the list of discovered business flows wherein new business flows are created based on new requests.

5. The method of claim 4, wherein the business flows are created based on:
business flows that involve the execution of specific services and underlying operations within them;
business flows that involve a combination of specified metrics or tagged fields in the service operations in the business flow; and
business flows whose services are associated with specific computing infrastructure such as compute server or storage device or a network device used by a service in the business flow.

6. A method of claim 5, wherein a problem is detected in a business flow and in the traces that belong to the business flow by:
automatically estimating and setting a service level objective (SLO) on the performance, availability or other metric using probabilistic mechanisms such percentile of values over a sliding window of time;
modifying the SLO setting when there is a change in the rate of arrival or performance of the incoming traces that comprises the business flows; and
detecting when the SLO of the business flow or a trace that belongs to the business flow is breached.

7. The method of claim 6 for isolating the services and operations cause SLOs for a business flow to be breached
using different mechanisms derived from performance, availability or other metrics of individual services and operations within the business flow that affect the aggregate SLO of the business flow.

8. The method of claim 7 further comprising:
distributing the processing across the business flow processing controller and at the source of collection of the traces by pre-processing and filtering the trace data.

9. The method of claim 8 further comprising:
reducing the volume of data from the collection source to increase the number of traces than can be aggregated and forwarded to the business flow processing controller; and
increasing the rate at which business flows are discovered and monitored.
